(19) United States
(12) Patent Application Publication
(10) Pub. No.: US 2008/0168494 A1
(43) Pub. Date: Jul. 10, 2008

(54) METHODS, ARRANGEMENTS AND COMPUTER PROGRAM PRODUCTS FOR DIGITAL MEDIA PRODUCTION

(75) Inventor: Timo RUOHOMAKI, Helsinki (FI)

Correspondence Address: YOUNG & THOMPSON, 209 Madison Street, Suite 500, ALEXANDRIA, VA, 22314, US

(73) Assignee: AIRSHIFT MEDIA OY, HELSINKI (FI)

(21) Appl. No.: 11/970,119

(22) Filed: Jan. 7, 2008

(30) Foreign Application Priority Data
Jan. 5, 2007 (FI) 20075005

(51) Int. Cl. G06F 3/00

(52) U.S. Cl. 725/38

(57) ABSTRACT

A method for managing media broadcasts, such as radio, TV and Internet broadcasts, includes a computer system for compiling a work for broadcasting from media files, and a graphical user interface through which the work is compiled. At least one computer script is configured for at least one specific folder and folder action, a media file is saved to or removed from the folder, or the folder is opened, closed, and/or resized in the graphical user interface, the computer script performs specific tasks based on the specific action and specific folder. The inventive methods and arrangements allow the seamless interfacing of Media Production Tool computer systems and Media Asset Management Systems, even when the systems employ different metadata. The methods and arrangements of the invention can be applied in general file transfer between two computer systems, and general file transfer between two computer software systems or more than two systems.

### TECHNICAL FIELD OF INVENTION

The invention relates to the field of digital media. In particular the invention relates to a method and means to provide improvements on digital media production of broadcasts.

### BACKGROUND

Various media for electronic broadcasting exist today, such as radio, television and web casting on the Internet, The use of digital media, for example the use of media files, has greatly improved the efficiency of media production.

In the present art, a Media Production Tool is a program used to produce the broadcast, and a Media Asset Management system is used to store assets that consist of media files, their metadata and related data. We will adhere to these names and definitions in this application.

Irrespective of the advantages these digital systems exhibit, they are still hindered by a number of disadvantages. The prior art does not address how a Media Production Tool could be interfaced with a Media Asset Management System in an efficient and user-friendly manner. Both of these systems use different applications, and require different metadata. As the metadata is not standardized, it has been very difficult to interface the two systems because hard-coded individual solutions are needed. Poor functionality of the interface between the systems also means that it is difficult to keep the data files updated in the Media Asset Management System, which involves quality risks in the broadcasting operation. Quite clearly, the field of digital media production is burdened by the lack of suitable interfacing and integration between Media Production Tools and Media Asset Management Systems.

### SUMMARY OF THE INVENTION

The invention under study is directed towards a system and a method for effectively managing and compiling digital media broadcasts. A further object of the invention is to present system and a method that integrates the Media Production tool part and Media Asset Management System part in the production of digital broadcasts, without a need to make changes in the applications used by these two parts.

One aspect of the invention addresses the objectives of the invention by using a combination of known operating system features with unique software to extend the operating system's way of handling files with handling any type of metadata and related data as well.

One embodiment of the invention uses a computer with a graphical user interface, where the folders are configured with computer scripts. When a Media Production Tool is used and a media file is saved to or removed from a folder, or when the folder is opened (e.g. the contents of the folder is shown for the user), closed, and/or resized (e.g. a window showing the folder contents is resized) the computer script configured to this specific action and this specific folder is run. The computer script then triggers an application that presents a user dialog that queries all necessary metadata. After the user has entered sufficient metadata, an XML file is generated on the basis of the entered metadata. The XML file thus usefully comprises the entered metadata and possibly other, previously stored metadata. This XML file is uploaded together with the media file to the Media Asset Management System. Metadata is thus conserved and adapted between the two systems, and the two parts can be used seamlessly. Since a markup language, such as XML, is generally adopted by different types of systems, such as Media Production Tool and Media Asset Management System, the straightforward exchange of metadata is achieved between the systems.

It is useful to upload the files directly between the systems, such as Media Production Tool and the Media Asset Management System, without intermediate storing into an intermediate database. Especially, it is useful not to use an intermediate storage according to some further, different format.

Thus, in a system according to the invention, it is not necessary provide any intermediate databases for intermediate storing of the files, and not necessary to provide separate translation means for translating between different formats used by the Media Production Tool, Media Asset Management System and any intermediate database.

According to another aspect of the invention, the computer script set for the folder can be replaced by frequently polling the folder, and triggering an executable program whenever a file is added.

The previous embodiments can be adapted to general file transfer between two computer systems without the data file necessarily having to be a media file. The two embodiments are thus applicable to general file transfer as well.

In the present solution, it is possible to connect a media data file to a media file in a user interface level in such a way that the process can be implemented with existing application software. The present solution is thus usefully implemented at a client, instead of some prior art solutions with their functionalities located at a server.

A method for managing media broadcasts, such as radio-, TV- and Internet broadcasts, in accordance with the invention using a computer system for compiling a work for broadcasting from media files, and a graphical user interface through which the work is compiled is characterised in that
at least one computer script is configured for at least one specific folder and folder action,
a media file is saved to or removed from said folder, or the folder is opened, closed, and/or resized in the graphical user interface,
the computer script is run,
specific tasks are performed by the computer script based on the specific action and specific folder.

A method for managing media broadcasts, such as radio-, TV- and Internet broadcasts, in accordance with the invention using a computer system for compiling a work for broadcasting from media files, and a graphical user interface through which the work is compiled is characterised in that
at least one executable program is configured for at least one specific folder and folder action,
at least one folder is polled by the computer system,
at least one media file is saved to or removed from said folder, or the folder is opened, closed, and/or resized in the graphical user interface,
executable program is triggered for execution by the computer system based on the action and folder,
specific tasks are performed by the executable program based on the action and folder.

A method for electronic processing of files in accordance with the invention comprises using a first computer system with a graphical user interface and a second computer system and is characterised in that
the graphical user interface further comprises at least one folder which is configured with at least one computer script and/or at least one folder which is polled by the first computer system,
a data file is saved to or removed from said folder, or the folder is opened, closed, and/or resized,
the computer script configured to the specific action and specific folder is run, and/or an executable program is triggered for execution by the first computer system,
specific tasks are performed by the executable program based on the action and folder and/or specific tasks are performed by the computer script based on the specific action and specific folder,
a user dialog is conducted by an application defined by the computer script or the executable program,
the user uses the user dialog to enter fields for metadata that is used to define the file,
said application contains an FTP client and an XML file is generated by a Save-action after user has entered said metadata,
the XML file and the media file are uploaded into the second computer system.

An arrangement for managing media broadcasts, such as radio-, TV- and Internet broadcasts, in accordance with the invention comprises a computer system for compiling a work for broadcasting from media files, and a graphical user interface through which the work is arranged to be compiled is characterised in that
at least one computer script is arranged to be configured for at least one specific folder and folder action,
a media file is arranged to be saved to or removed from said folder, or the folder is arranged to be opened, closed, and/or resized in the graphical user interface,
the computer script is arranged to be run,
specific tasks are arranged to be performed by the computer script based on the specific action and specific folder.

An arrangement for managing radio-, TV- and Internet broadcasts in accordance with the invention comprises a computer system for compiling a work for broadcasting from media files, and a graphical user interface through which the work is arranged to be compiled is characterised in that
at least one executable program is arranged to be configured for at least one specific folder and folder action,
at least one folder is arranged to be polled by the computer system,
at least one media file is arranged to be saved to or removed from said folder, or the folder is arranged to be opened, closed, and/or resized in the graphical user interface,
executable program is arranged to be triggered for execution by the computer system based on the action and folder,
specific tasks are arranged to be performed by the executable program based on the action and folder.

An arrangement for electronic processing of files in accordance with the invention comprises a first computer system with a graphical user interface and a second computer system is characterised in that
the graphical user interface is further arranged to comprise at least one folder which is configured with at least one computer script and/or at least one folder which is arranged to be polled by the first computer system,
a data file is arranged to be saved to or removed from said folder, or the folder is arranged to be opened, closed, and/or resized,
the computer script configured to the specific action and specific folder is arranged to be run, and/or an executable program is arranged to be triggered for execution by the first computer system,
specific tasks are arranged to be performed by the executable program based on the action and folder and/or specific tasks are arranged to be performed by the computer script based on the specific action and specific folder,
a user dialog is arranged to be conducted by an application defined by the computer script or the executable program,
the user dialog is arranged to contain fields for metadata that is arranged to define the file,
said application is arranged to contain an FTP client and an XML file is arranged to be generated by a Save-action after user has entered said metadata,
the XML file and the media file are arranged to be uploaded into the second computer system.

Computer program product in accordance with the invention comprises a computer program stored on a computer readable storage medium for managing media broadcasts, such as radio, TV and Internet broadcasts, further comprising a computer program for compiling a work for broadcasting from media files, and a graphical user interface through which the work is arranged to be compiled and is characterised in that
at least one computer script is arranged to be configured for at least one specific folder and folder action,
a media file is arranged to be saved to or removed from said folder, or the folder is arranged to be opened, closed, and/or resized in the graphical user interface,
the computer script is arranged to be run,
specific tasks are arranged to be performed by the computer script based on the specific action and specific folder.

Computer program product in accordance with the invention comprises a computer program stored on a computer readable storage medium for managing media broadcasts, such as radio-, TV- and Internet broadcasts, further comprising a computer program for compiling a work for broadcasting from media files, and a graphical user interface through which the work is arranged to be compiled and is characterised in that
at least one executable program is arranged to be configured for at least one specific folder and folder action,
at least one folder is arranged to be polled by the computer system,
at least one media file is arranged to be saved to or removed from said folder, or the folder is arranged to be opened, closed, and/or resized in the graphical user interface,
executable program is arranged to be triggered for execution by the computer system based on the action and folder,
specific tasks are arranged to be performed by the executable program based on the action and folder.

Computer program product in accordance with the invention comprises a computer program stored on a computer readable storage medium for electronic processing of files, further comprising a first computer system software with a graphical user interface and a second computer system software and is characterised in that
the graphical user interface is further arranged to comprise at least one folder which is configured with at least one computer script and/or at least one folder which is arranged to be polled by the first computer system software,
a data file is arranged to be saved to or removed from said folder, or the folder is arranged to be opened, closed, and/or resized,
the computer script configured to the specific action and specific folder is arranged to be run, and/or an executable program is arranged to be triggered for execution by the first computer system software,
specific tasks are arranged to be performed by the executable program based on the action and folder and/or specific tasks are arranged to be performed by the computer script based on the specific action and specific folder,
a user dialog is arranged to be conducted by an application defined by the computer script or the executable program,
the user dialog is arranged to contain fields for metadata that is arranged to define the file,
said application is arranged to contain an FTP client and an XML file is arranged to be generated by a Save-action after user has entered said metadata,
the XML file and the media file are arranged to be uploaded into the second computer system software.

Some useful embodiments of the invention are described in dependent claims.

In addition and with reference to the aforementioned advantage accruing embodiments, the best mode of the invention is considered to be the use of “Folder Action” feature from Mac OS X™ operating system to make folder specific scripts that instruct an application with an FTP (File Transfer Protocol) client to query the metadata, generate an XML file and to upload the media file and the XML file to the Media Asset Management System.

### BRIEF DESCRIPTION OF THE DRAWINGS

In the following the invention will be described in greater detail with reference to exemplary embodiments in accordance with the accompanying drawings, in which

FIG. 1 demonstrates an embodiment of the inventive method based on computer scripting as a flow diagram.

FIG. 2 demonstrates an embodiment of the inventive method based on triggered executables as a flow diagram.

FIG. 3 demonstrates a more elaborate embodiment of the inventive method based on computer scripting and uploading as a flow diagram.

FIG. 4 demonstrates a more elaborate embodiment of the inventive method 40 based on triggered executables and uploading as a flow diagram.

FIG. 5 demonstrates embodiment of the inventive method where the invention is used in conventional file transfer between two computer systems.

FIG. 6 demonstrates an embodiment of the inventive arrangement based on computer scripting as a block diagram.

FIG. 7 demonstrates an embodiment of the inventive arrangement based on triggered executables as a block diagram.

FIG. 8 demonstrates a more elaborate embodiment of the inventive arrangement based on computer scripting and uploading as a block diagram.

FIG. 9 demonstrates a more elaborate embodiment of the inventive arrangement based on triggered executables and uploading as a block diagram.

### DETAILED DESCRIPTION

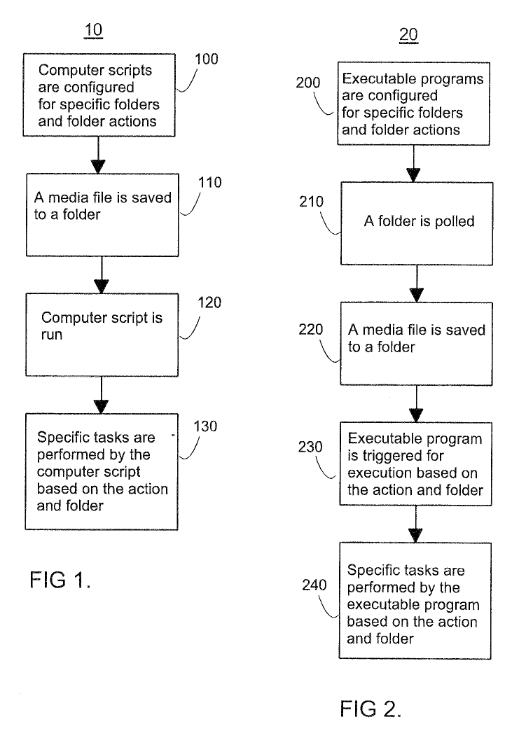

FIG. 1 discloses a method for managing media broadcasts, such as radio-, TV- and Internet broadcasts. The method 10 is typically performed with a computer system for compiling a work for broadcasting from media files, and a graphical user interface through which the work is compiled, i.e. a Media Production Tool. The graphical user interface is typically a computer mouse operated interface. In phase 100 at least one computer script is configured for at least one specific folder and folder action. The folder can be any folder used in conventional computer architecture for storing files and programs. The folder action is an action performed on the folder, such as adding, updating or removing a file. Also opening, closing and resizing the folder qualify as folder actions. In phase 110 a media file is saved to or removed from said folder, or the folder is opened, closed, and/or resized in the graphical user interface, i.e. a folder action is performed. Provided that this is the folder for which the computer script is specified and this is also the action for which the computer script is specified, the computer script is run in phase 120. In other words the computer script is run as a response to the folder action.

In phase 130 specific tasks are performed by the computer script based on the specific action and specific folder. These tasks are typically directed towards interfacing the Media Production Tool with some Media Asset Management System, but the tasks may also be other tasks. An example of a task could be conducting a user dialog by an application defined by the computer script or the executable program.

It is obvious that any of the phases of method 10 can be executed in a changed order, or in parallel. It is also obvious that the method 10 can be combined and permuted with any of the following methods 20, 30, 40 and/or 50 and their respective phases.

FIG. 2 discloses another method for managing radio-, TV- and Internet broadcasts. The method 20 is typically also performed with a computer system for compiling a work for broadcasting from media files, and a graphical user interface through which the work is compiled i.e. a Media Production Tool. In phase 200 at least one executable program is configured for at least one specific folder and folder action. The executable program is understood by it being any program that could be executed by the operating system. In the MS-DOS/Windows environment these program files have been typically labelled “exe”-files by their end definition, for example. In phase 210 at least one folder is polled by the computer system. The polling can take place at regular or irregular, short or long intervals. By the polling the computer system can observe when at least one media file is saved to or removed from said folder, or the folder is opened, closed, and/or resized in the graphical user interface, phase 220. If this folder and the associated folder action were configured for a particular executable, this particular executable program is triggered for execution by the computer system based on the action and folder in phase 230. In other words, the executable program is triggered as a response to the folder action.

After this, the executable is typically run, and specific tasks are performed by the executable program based on the action and folder in phase 240. These tasks are typically directed towards interfacing the Media Production Tool with some Media Asset Management System, but the tasks may also be other tasks. An example of a task could be conducting a user dialog by an application defined by the executable program.

It is obvious that any of the phases of method 20 can be executed in a changed order, or in parallel. It is also obvious that the method 20 can be combined and permuted with any of the methods 10, 30, 40 and/or 50 and their respective phases.

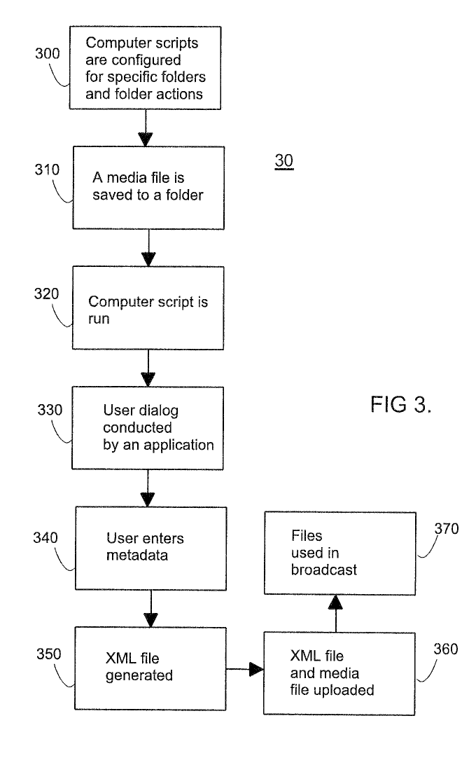

In FIG. 3, phase 300 at least one computer script is configured for at least one specific folder and folder action, as explained before. A folder action then takes place as a media file is saved to or removed from said folder, or the folder is opened, closed, and/or resized in the graphical user interface phase 310. This causes the configured computer script to be run in phase 320. The running of the computer script activates an application in phase 330 and a user dialog is conducted by an application defined by the computer script. In this dialog the user uses the user dialog to enter fields for metadata that is used to define the file, phase 340. Metadata can involve file formats, time, place, host and/or version of the file, or any data that can be used to define the file and its contents.

In phase 350 an XML (Extended Mark-up Language) file is generated by a Save-action or some other action after a user has entered said metadata. XML is defined as a set of syntactical and grammatical rules for specifying the contents and structure of text documents utilizing markup. It is naturally possible to use some a file according to some other markup language instead of XML. In some embodiments, said application contains an FTP client. In phase 360 the generated XML file and the original media file that participated in the folder action are uploaded to a Media Asset Management System. A Media Asset Management System can reside on a server computer, for example. The application may use the FTP client for uploading, but in addition to this other forms of uploading can be used as well.

In phase 370 the work compiled or the files used in the compilation, or some part or number of them are broadcasted over radio, TV or the Internet. The broadcast can be made from either the Media Production Tool or from the Media Asset Management System.

It is obvious that any of the phases of method 30 can be executed in a changed order, or in parallel. It is also obvious that the method 30 can be combined and permuted with any of the methods 10, 20, 40 and/or 50 and their respective phases.

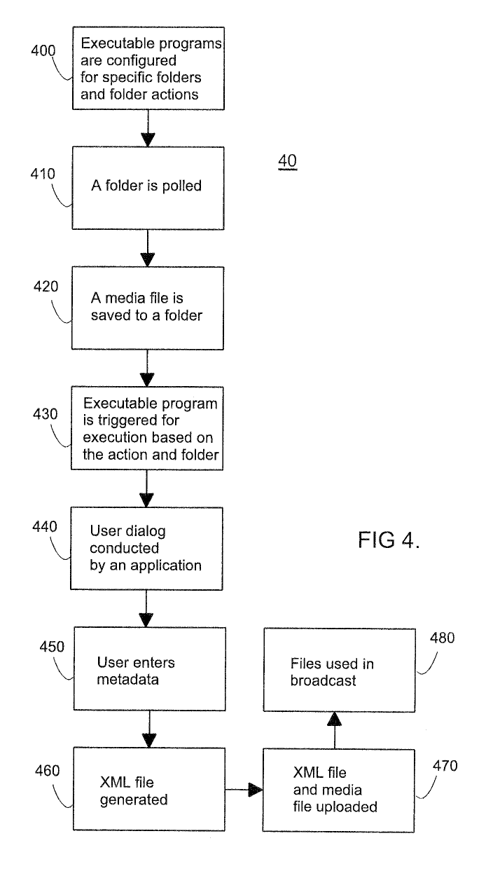

In FIG. 4, phase 400, at least one executable program is configured for at least one specific folder and folder action. The computer system used in method 40 is similar to method 20. In phase 410 at least one folder is polled by the computer system 410. The polling signal is typically administered by the operating system, but it is also possible that there is an application that polls various specified folders. In phase 420 at least one media file is saved to or removed from said folder, or the folder is opened, closed, and/or resized in the graphical user interface. The graphical user interface is typically a computer mouse operated interface. An executable program is triggered for execution by the computer system based on the action and folder in phase 430. The triggering may start the execution of the executable program immediately, at a later time or upon the fulfillment of a further condition. In phase 440 a user dialog is conducted by an application defined by the executable program. The user uses the user dialog to enter fields for metadata that is used to define the file in phase 450. Metadata can involve file formats, time, place, host and/or version of the file, or any data that can be used to define the file and its contents.

In phase 460 an XML file is generated by the Save-action after a user has entered said metadata. The XML file and the media file are uploaded into a Media Asset Management system in phase 470. In some embodiments, said application also typically contains an FTP client. In these cases the FTP client is typically used for uploading, but it is possible to use other uploading methods in accordance with the invention. In phase 480, the work is broadcasted from said computer system and/or from Media Asset Management System to the media, such as TV, radio or the Internet. In addition to simply broadcasting the work, various parts of the work can be broadcast, and the work can be used in combination with other media works for broadcast.

It is completely obvious that any of the phases of method 40 can be executed in a changed order, or in parallel. It is also completely obvious that the method 40 can be combined and permuted with any of the methods 10, 20, 30 and/or 50 and their respective phases.

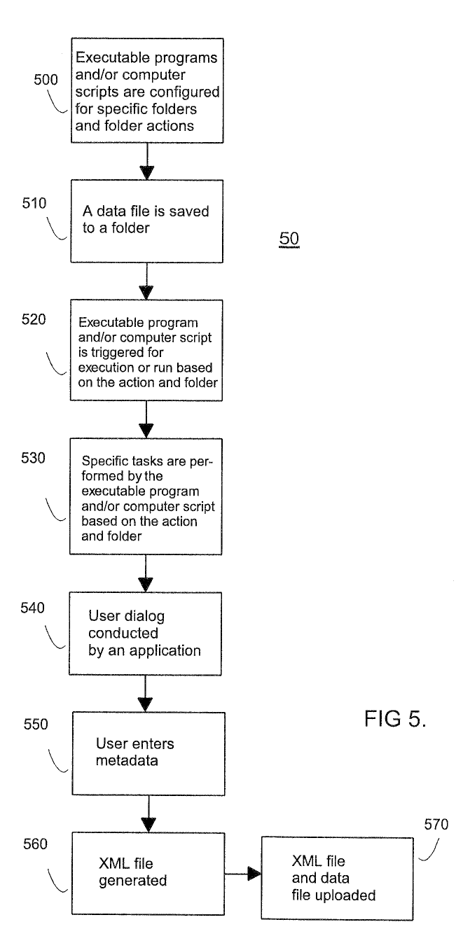

FIG. 5 discloses a general method for electronic processing of files, comprising a first computer system with a graphical user interface and a second computer system. The computer systems can be any systems, clients or servers, and the graphical user interface can be any visually operated user interface. In phase 500 the graphical user interface further comprises at least one folder which is configured with at least one computer script and/or at least one folder which is polled by the first computer system. In this method the folder observation techniques of methods 10 and 20 can thus be used in combination. In phase 510 a data file is saved to or removed from said folder, or the folder is opened, closed, and/or resized. The data file is any computer file containing data, and not limited to media data. The folder can be any directory or folder used in a computer system. In other words, the computer system observes a folder action independently or by polling, and as a response executes phase 520.

In phase 520 the computer script configured to the specific action and specific folder is run and/or an executable program is triggered for execution by the first computer system. In this method the data handling and file manipulation techniques of methods 10 and 20 can thus be used in combination. In phase 530 specific tasks are performed by the executable program based on the action and folder and/or specific tasks are performed by the computer script based on the specific action and specific folder 530.

In phase 540 a user dialog is conducted by an application defined by the computer script or the executable program. The user uses the user dialog to enter fields for metadata that is used to define the file in phase 550, similarly to previous methods.

An XML file is generated by the Save-action after user has entered said metadata in phase 560, and the XML file and the media file are uploaded into the second computer system in phase 570. Naturally, said application contains an FTP client in some embodiments, and can use it alongside other methods for uploading.

It is obvious that any of the phases of method 50 can be executed in a changed order, or in parallel. It is also obvious that the method 50 can be combined and permuted with any of the methods 10, 20, 30 and/or 40 and their respective phases.

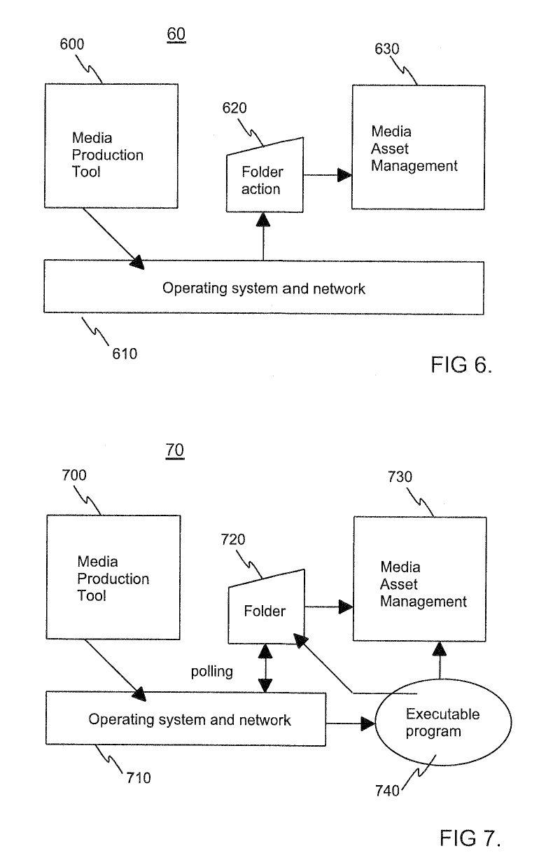

FIG. 6 presents an arrangement 60 for managing and compiling media broadcasts such as radio-, TV- and Internet broadcasts as a block diagram. The arrangement comprises a computer system with a Media Production Tool 600 and an operating system with a network connection 610. The computer system is used for compiling a work for broadcasting from media files, and has a graphical user interface through which the work is arranged to be compiled. The graphical user interface can be operated e.g. by a computer mouse or keypad. In the computer system 600, 610 at least one computer script is arranged to be configured for at least one specific folder and folder action 620. A folder is here understood as a directory for storing files in a computer system, as defined previously, and a folder action is any action executed upon a folder. When a media file is arranged to be saved to or removed from said folder, or the folder is arranged to be opened, closed, and/or resized in the graphical user interface, the computer script is arranged to be run. Specific tasks are arranged to be performed by the computer script based on the specific action and specific folder, which may entail for example the conversion and interfacing of the metadata used by the Media Production Tool to a format that may be understood by the Media Asset Management System.

Quite clearly any components of arrangement 60 can be used in combination with any elements from arrangements 70, 80 and 90 in accordance with the invention.

FIG. 7 presents an arrangement 70 for managing and compiling radio-, TV- and Internet broadcasts. The arrangement comprises a computer system with a Media Production Tool 700 and an operating system and network connection 710. The computer system 700, 710 is used for compiling a work for broadcasting from media files, and it also comprises a graphical user interface through which the work is arranged to be compiled. The arrangement also comprises at least one executable program 740 stored in the computer system, or saved in a memory or disk location that may be accessed by the computer system 700, 710. This executable program 740 is arranged to be configured for at least one specific folder and folder action 720. A folder is here understood as a directory for storing files in a computer system, as defined previously, and a folder action is any action executed upon a folder.

At least one folder 720 is arranged to be polled by the computer system 700, 710 continuously or at any intervals. When at least one media file is arranged to be saved to or removed from said folder, or the folder is arranged to be opened, closed, and/or resized in the graphical user interface, the polling is arranged to detect this action. As a consequence to detecting this action an executable program 740 is arranged to be triggered for execution by the computer system 700, 710 based on the action and folder. The triggering may execute the executable program 740 immediately, at a later defined time, or upon fulfillment of further criteria. However, specific tasks are arranged to be performed by the executable program 740 based on the action and folder, which may entail for example the conversion and interfacing of the metadata used by the Media Production Tool to a format that may be understood by the Media Asset Management System.

Quite clearly any components of arrangement 70 can be used in combination with any elements from arrangements 60, 80 and 90 in accordance with the invention.

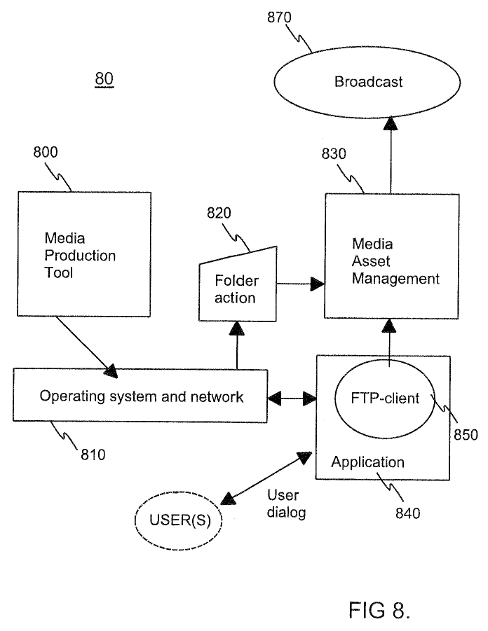

FIG. 8 aims to present a more detailed version of the arrangement 60. In the computer system 800, 810 at least one computer script is arranged to be configured for at least one specific folder and folder action. Computer scripts may also be configured by the application 840 in some embodiments. When a media file is arranged to be saved to or removed from said folder, or the folder is arranged to be opened, closed, and/or resized in the graphical user interface, the computer script associated with the folder and the folder action 820 is arranged to be run. Specific tasks are arranged to be performed by the computer script based on the specific action and specific folder. For example, a user dialog is arranged to be conducted by an application 840 defined by the computer script. The user dialog is arranged to contain fields for metadata that is arranged to define the media file in some embodiments. Metadata can involve file formats, time, place, host and/or version of the file, or any data that can be used to define the file and its contents.

In some embodiments, an XML file is arranged to be generated by a Save-action after user has entered said metadata. The XML file and the media file are arranged to be uploaded into a Media Asset Management System 830. Said application 840 is arranged to contain an FTP client 850 in some embodiments. The FTP client, or any other communication software for that matter, is arranged to be used in uploading the compiled work or media file with the XML file to the Media Asset Management System. In some embodiments the work is further arranged to be broadcasted 870 over the radio waves, television network or the Internet from said computer system 800, 810 and/or from Media Asset Management System 830.

Quite clearly any components of arrangement 80 can be used in combination with any elements from arrangements 60, 70 and 90 in accordance with the invention.

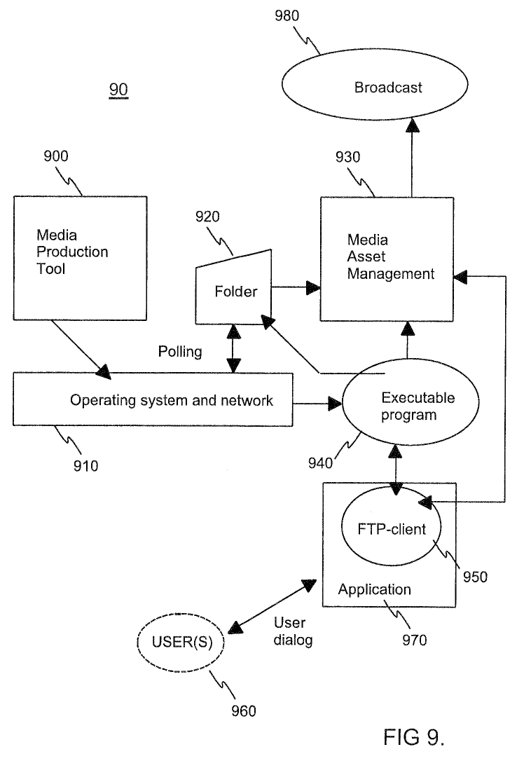

FIG. 9 aims to present a more detailed version of the arrangement 70. In this arrangement at least one executable program 940 is arranged to be configured for at least one specific folder and folder action. At least one folder 920 is arranged to be polled by the computer system 900, 910. In some embodiments the application 970 may also be arranged to do the polling. The polling can be continuous or it can take place at any regular or irregular intervals. At least one media file is arranged to be saved to or removed from said folder, or the folder is arranged to be opened, closed, and/or resized in the graphical user interface, and as the polling detects this, an executable program 940 is arranged to be triggered for execution by the computer system 900, 910 based on the action and folder. The triggering may execute the executable immediately, at a later time or upon the fulfillment of further criteria. Specific tasks are arranged to be performed by the executable program 940 based on the action and folder.

For example, a user dialog is arranged to be conducted by an application 970 defined by the executable program 940. The user dialog is arranged to contain fields for metadata that is arranged to define the media file. An XML file is arranged to be generated by the Save-action after user has entered said metadata. The XML file and the media file are arranged to be uploaded into a Media Asset Management system 930. In some embodiments the application 970 is arranged to contain an FTP client 950. This FTP client 950 may be used for uploading, or other communication software methods may be employed as well.

In some embodiments the work is arranged to be broadcasted to radio- or television network, or the Internet 980 from said computer system 900, 910 and/or from Media Asset Management System 930. Likewise the work can be integrated with another work, or only parts of the work can be made a broadcast 980.

Quite clearly any components of arrangement 90 can be used in combination with any elements from arrangements 60, 70 and 80 in accordance with the invention. It is further obvious that the methods and the arrangements of the invention can be realised as a computer program product, comprising at least one computer program stored on a computer readable storage medium.

The invention has been explained above with reference to the aforementioned embodiments and several commercial and industrial advantages have been demonstrated. The methods and arrangements of the invention allow the seamless interfacing of Media Production Tool computer systems and Media Asset Management systems, even when said systems employ different form of metadata or different operating systems. Further the methods and arrangements of the invention can be applied in general file transfer between two computer systems, and general file transfer between two computer software systems or more than two said systems.

The invention has been explained above with reference to the aforementioned embodiments. However, it is clear that the invention is not only restricted to these embodiments, but comprises all possible embodiments within the spirit and scope of the inventive thought and the following patent claims.

For example, instead of an XML file it is naturally possible to use a file of some other markup language in the related embodiments. Also, instead of a FTP client, it is possible to use some other, similar client for the transfer of data.

Further, one should note that instead of an action phase where a file is saved to or removed from said folder, or the folder is opened, closed, and/or resized in the graphical user interface, there may be a phase where only one or part of these functionalities is possible as alternatives. For example, it is possible that only saving a file is such an action which triggers running a script or executing a program.

1. A method for managing media broadcasts, such as radio, TV and Internet broadcasts, using a computer system (600, 610, 800, 810) for compiling a work for broadcasting from media files, and a graphical user interface through which the work is compiled, characterised in that
at least one computer script is configured for at least one specific folder and folder action (100, 300),
a media file is saved to or removed from said folder, or the folder is opened, closed, and/or resized in a graphical user interface (110, 310),
the computer script is run (120, 320)
specific tasks are performed by the computer script based on the specific action and specific folder (130).

2. A method for managing media broadcasts, such as radio, TV and Internet broadcasts, using a computer system (700, 710, 900, 910) for compiling a work for broadcasting from media files, and a graphical user interface through which the work is compiled, characterised in that
at least one executable program is configured for at least one specific folder and folder action (200, 400),
at least one folder is polled by the computer system (210, 410),
at least one media file is saved to or removed from said folder, or the folder is opened, closed, and/or resized in the graphical user interface (220, 420),
executable program is triggered for execution by the computer system based on the action and folder (230, 430),
specific tasks are performed by the executable program based on the action and folder (240).

3. A method as claimed in claim 1, characterised in that a user dialog is conducted by an application defined by the computer script or the executable program (330, 440).

4. A method as claimed in claim 3, characterised in that the user uses the user dialog to enter fields for metadata that is used to define a file (340, 450).

5. A method as claimed in claim 3, characterised in that said application contains an FTP client (850, 950).

6. A method as claimed in claim 4, characterised in that an XML file is generated by a Save-action after user has entered said metadata (350, 460).

7. A method as claimed in claim 4, characterised in that the XML file and the media file are uploaded into a Media Asset Management system (360, 470).

8. A method as claimed in claim 1, characterised in that the work is broadcasted from said computer system (600, 610, 700, 710, 800, 810, 900, 910) and/or from Media Asset Management System (370, 480).

9. A method for electronic processing of files, using a first computer system with a graphical user interface and a second computer system, characterised in that
the graphical user interface further comprises at least one folder which is configured with at least one computer script and/or at least one folder which is polled by the first computer system (500),
a data file is saved to or removed from said folder, or the folder is opened, closed, and/or resized (510),
the computer script configured to the specific action and specific folder is run, and/or an executable program is triggered for execution by the first computer system (520),
specific tasks are performed by the executable program based on the action and folder and/or specific tasks are performed by the computer script based on the specific action and specific folder (530),
a user dialog is conducted by an application defined by the computer script or the executable program (540)
the user uses the user dialog to enter fields for metadata that is used to define the file (550),
said application contains an FTP client and an XML file is generated by the Save-action after user has entered said metadata (560),
the XML file and the media file are uploaded into the second computer system (570).

10. An arrangement for managing media broadcasts, such as radio, TV or Internet broadcasts, comprising a computer system (600, 610, 800, 810) for compiling a work for broadcasting from media files, and a graphical user interface through which the work is arranged to be compiled, characterised in that
at least one computer script is arranged to be configured (100, 300) for at least one specific folder and folder action (620, 820),
a media file is arranged to be saved to or removed from said folder, or the folder is arranged to be opened, closed, and/or resized in the graphical user interface (110, 310),
the computer script is arranged to be run (120, 320),
specific tasks are arranged to be performed by the computer script based on the specific action and specific folder (130).

11. An arrangement for managing media broadcasts, such as radio, TV and Internet broadcasts, comprising a computer system (700, 710, 900, 910) for compiling a work for broadcasting from media files, and a graphical user interface through which the work is arranged to be compiled, characterised in that
at least one executable program (740, 940) is arranged to be configured (200, 400) for at least one specific folder and folder action (720, 920),
at least one folder (720, 920) is arranged to be polled by the computer system (710),
at least one media file is arranged to be saved to or removed from said folder, or the folder is arranged to be opened, closed, and/or resized in the graphical user interface (220, 420),
executable program (740, 940) is arranged to be triggered for execution by the computer system (710, 910) based on the action and folder,
specific tasks are arranged to be performed by the executable program (740, 940) based on the action and folder (240).

12. An arrangement as claimed in claim 10, characterised in that a user dialog is arranged to be conducted (330, 440) by an application (840, 970) defined by the computer script or the executable program (740, 940).

13. An arrangement as claimed in claim 12, characterised in that the user dialog is arranged to contain fields for metadata that is arranged to define a file (340, 450).

14. An arrangement as claimed in claim 12, characterised in that said application is arranged to contain an FTP client (850, 950).

15. An arrangement as claimed in claim 13, characterised in that an XML file is arranged to be generated by the Save-action after user has entered said metadata (350, 460).

16. An arrangement as claimed in claim 13, characterised in that the XML file and the media file are arranged to be uploaded (360, 470) into a Media Asset Management system (630, 730, 830, 930).

17. An arrangement as claimed in claim 10, characterised in that the work is arranged to be broadcasted (370, 480), (870, 980) from said computer system (600, 610, 700, 710, 800, 810, 900, 910) and/or from Media Asset Management System (630, 730, 830, 930).

18. An arrangement for electronic processing of files, comprising a first computer system with a graphical user interface and a second computer system, characterised in that
the graphical user interface is further arranged to comprise at least one folder which is configured with at least one computer script and/or at least one folder which is arranged to be polled by the first computer system (500),
a data file is arranged to be saved to or removed from said folder, or the folder is arranged to be opened, closed, and/or resized (510)
the computer script configured to the specific action and specific folder is arranged to be run, and/or an executable program is arranged to be triggered for execution by the first computer system (520),
specific tasks are arranged to be performed by the executable program based on the action and folder and/or specific tasks are arranged to be performed by the computer script based on the specific action and specific folder (530),
a user dialog is arranged to be conducted by an application defined by the computer script or the executable program (540),
the user dialog is arranged to contain fields for metadata that is arranged to define the file (550),
said application is arranged to contain an FTP client and an XML file is arranged to be generated by the Save-action after user has entered said metadata (560),
the XML file and the media file are arranged to be uploaded into the second computer system (570).

19. Computer program product, comprising a computer program stored on a computer readable storage medium for managing media broadcasts, such as radio, TV and Internet broadcasts, further comprising a computer program (600, 800) for compiling a work for broadcasting from media files, and a graphical user interface through which the work is arranged to be compiled, characterised in that
at least one computer script is arranged to be configured (100, 300) for at least one specific folder and folder action (620, 820)
a media file is arranged to be saved to or removed from said folder, or the folder is arranged to be opened, closed, and/or resized in the graphical user interface (110, 310),
the computer script is arranged to be run (120, 320),
specific tasks are arranged to be performed by the computer script based on the specific action and specific folder (130).

20. Computer program product, comprising a computer program stored on a computer readable storage medium for managing media broadcasts, such as radio, TV and Internet broadcasts, further comprising a computer program (700, 900) for compiling a work for broadcasting from media files, and a graphical user interface through which the work is arranged to be compiled, characterised in that
at least one executable program (740, 940) is arranged to be configured for at least one specific folder and folder action (720, 920),
at least one folder (720, 920) is arranged to be polled by the computer system (710),
at least one media file is arranged to be saved to or removed from said folder, or the folder is arranged to be opened, closed, and/or resized in the graphical user interface (220, 420)
executable program (740, 940) is arranged to be triggered for execution by the computer system (710, 910) based on the action and folder,
specific tasks are arranged to be performed by the executable program (740, 940) based on the action and folder (240).

21. Computer program product as claimed in claim 19, characterised in that a user dialog is arranged to be conducted (330, 440) by an application (840, 970) defined by the computer script or the executable program (740, 940).

22. Computer program product as claimed in claim 21, characterised in that the user dialog is arranged to contain fields for metadata that is arranged to define a file (340, 450).

23. Computer program product as claimed in claim 21, characterised in that said application is arranged to contain an FTP client (850, 950).

24. Computer program product as claimed in claim 22, characterised in that an XML file is arranged to be generated by the Save-action after user has entered said metadata (350, 460).

25. Computer program product as claimed in claim 22, characterized in that the XML file and the media file are arranged to be uploaded (360, 470) into a Media Asset Management system (630, 730, 830, 930).

26. Computer program product as claimed in claim 19, characterised in that the work is arranged to be broadcasted (370, 480), (870, 980) from a computer system (600, 610, 700, 710, 800, 810, 900, 910) and/or from a Media Asset Management System (370, 480).

27. Computer program product, comprising a computer program stored on a computer readable storage medium for electronic processing of files, further comprising a first computer system software with a graphical user interface and a second computer system software, characterised in that
the graphical user interface is further arranged to comprise at least one folder which is configured with at least one computer script and/or at least one folder which is arranged to be polled by the first computer system software (500),
a data file is arranged to be saved to or removed from said folder, or the folder is arranged to be opened, closed, and/or resized (510),
the computer script configured to the specific action and specific folder is arranged to be run, and/or an executable program is arranged to be triggered for execution by the first computer system software (520),
specific tasks are arranged to be performed by the executable program based on the action and folder and/or specific tasks are arranged to be performed by the computer script based on the specific action and specific folder (530),
a user dialog is arranged to be conducted by an application defined by the computer script or the executable program (540),
the user dialog is arranged to contain fields for metadata that is arranged to define the file (550),
said application is arranged to contain an FTP client and an XML file is arranged to be generated by the Save-action after user has entered said metadata (560),
the XML file and the media file are arranged to be uploaded into the second computer system software (570).
